(19) United States
(12) Patent Application Publication
(10) Pub. No.: US 2020/0298763 A1
(43) Pub. Date: Sep. 24, 2020

(54) VEHICLE REARVIEW MIRROR

(71) Applicant: FU HWA MIRROR CO., LTD., CHANGHUA COUNTY (TW)

(72) Inventor: PIN-SHU HUANG, CHANGHUA COUNTY (TW)

(21) Appl. No.: 16/814,333

(22) Filed: Mar. 10, 2020

(30) Foreign Application Priority Data
Mar. 22, 2019 (TW) 108110113

(51) Int. Cl. B60R 1/12; B60Q 1/26

(52) U.S. Cl. CPC B60R 1/1207; B60Q 1/2665

(57) ABSTRACT

A vehicle rearview mirror includes a reflector having a light-transmissive pattern, and a light emitting module disposed behind the reflector and including a reflection base, a light source and a lens. The reflection base is hollow-shaped and provided on the inner wall thereof with a plurality of reflecting surfaces which gradually tilt one after another. The lens is mounted to the reflection base and has an inside surface and an outside surface. The inside surface is a matt surface. The outside surface faces the light-transmissive pattern. The light source is disposed on the reflection base in a way that the light emitted by the light source is reflected to the inside surface by the reflecting surfaces.

### BACKGROUND OF THE INVENTION

### 1. Field of the Invention

The present invention is a rearview mirror for general vehicles.

### 2. Description of the Related Art

A blind spot monitoring system detects objects around the body of a vehicle by a detector installed on the body of the vehicle. When the detector detects an object such as another vehicle, the driver is alerted through vision, hearing or vibration, which aids the driver to compensate the visual blind spots of vehicle to ensure driving safety.

In the conventional art, for example, U.S. Pat. No. 9,227,557 B2 describes a vehicle rearview mirror with an indicate function. Referring to FIG. 2 of the aforementioned patent, it is noted that the mirror surface 20 is provided with a light-transmissive zone 21 and an indicator device 30 is disposed behind the mirror surface 20. The indicator device 30 includes a reflection base 31 and light emitting members 32. The light emitting members 32 face a reflecting surface 311 of the reflection base 31, so that the light emitted by the light emitting members 32 is reflected by the reflecting surface 311 to the light-transmissive zone 21 to instruct the user.

However, the conventional indicator device 30 of the rearview mirror usually uses LEDS (light emitting diodes) as the light emitting members 32, and the LEDS are linear light sources only applicable to a small-area light-transmissive zone 21 as described in the above-mentioned patent, but inapplicable to a light-transmissive zone with a large area or a customized pattern, thereby limited in usage and still improvable.

### SUMMARY OF THE INVENTION

It is one of the objectives of the present invention to make an improvement aimed at the defects of the conventional rearview mirrors so as to provide an improved vehicle rearview mirror which can show a customized pattern with a larger area.

A vehicle rearview mirror according to an embodiment of the present invention is provided to include a reflector and a light emitting module. The reflector has a back surface provided with a light-transmissive pattern for alerting or instructing the driver. The light emitting module is disposed behind the reflector and includes a reflection base, a light source and a lens. The reflection base is hollow-shaped and provided on the inner wall thereof with a plurality of reflecting surfaces. The reflection base has an opening. The inside and the outside of the reflection base communicates with each other through the opening. The reflecting surfaces gradually tilt one after another from bottom to top and face the opening. The lens is mounted to the reflection base and covers the opening. The lens has an inside surface and an outside surface opposite to the inside surface. The inside surface is a matt surface. The outside surface faces the light-transmissive pattern. The light source is disposed on the reflection base and faces the reflecting surfaces.

Through the structural design of the above-described rearview mirror, the light emitted by the light source is reflected to the lens by the above-mentioned plurality of reflecting surfaces gradually tilting one after another. Then, through the matt design of the inside surface of the lens, the light reflected to the lens is uniformly diffused to the entire outside surface, so that the light emitting module emits a large-area light. In other words, the whole light emitting module can be regarded as a surface light source, thereby applicable to various light-transmissive patterns with large area and customized design, enabling the rearview mirror to show the above-mentioned light-transmissive pattern.

In one of the aspects, the rearview mirror may be a rear-view mirror inside the vehicle or a side-view mirror outside the vehicle.

In another aspect, the outside surface of the lens is a smooth surface.

In another aspect, the light source may include an LED array and the light source is fixed in the reflection base.

In another aspect, each of the reflecting surfaces is a curved surface, which may be designed in a way that the LEDS in the LED array face different reflecting surfaces to make the light reflected to the lens relatively more uniform.

In another aspect, the lens may include light diffusing agent therein to increase the diffusivity of the light projected from the lens.

In another aspect, for making the light emitting module stably fixed to the reflector and face the light-transmissive pattern, the light emitting module may be directly connected to the back surface of the reflector. In an alternative, the reflection base may be provided on the outer surface thereof with a bump in a way that the light emitting module can be directly connected to the back surface of the reflector by the bump.

In another aspect, each of the reflecting surfaces is a smooth curved surface formed by coating.

### BRIEF DESCRIPTION OF THE DRAWINGS

The detailed structure, features and assembly or usage manners of the vehicle rearview mirror of the present invention will be specified in a following embodiment, but it should be understood that the following embodiment and the accompanying drawings are given for illustration only, not limitative of the claimed scope of the present invention, and wherein:

FIG. 1 is a perspective view of a vehicle rearview mirror of the embodiment;

FIG. 2 is approximately a side view of FIG. 1, but doesn't show a mirror mount of the rearview mirror;

FIG. 3 is an exploded perspective view of a light emitting module of the embodiment;

FIG. 4 is a sectional view of the light emitting module of the embodiment; and

FIG. 5 is a block diagram showing the operation of a blind spot monitoring system of the embodiment.

### DETAILED DESCRIPTION OF THE INVENTION

The technology and features of the present invention will be specified in a following embodiment and the appendix drawings. The directional terms mentioned in the contents of the specification, such as ‘above’, ‘below’, ‘inside’, ‘outside’, ‘top’ and ‘bottom’, are just for illustrative description on the basis of normal usage direction, not intended to limit the claimed scope.

For specifying the technical features of the present invention, a following embodiment and the appendix drawings are given here under. This embodiment takes a side-view mirror outside the vehicle as an illustrative example of the rearview mirror of the present invention.

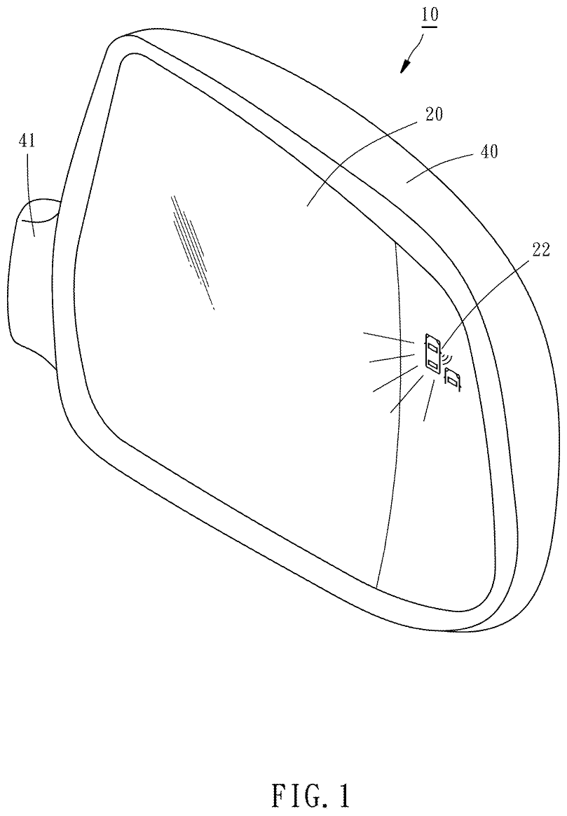

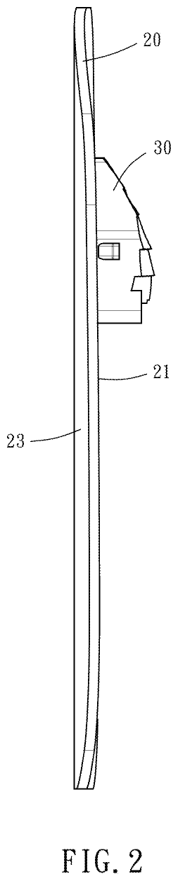

As shown in FIGS. 1-2, a rearview mirror 10 includes a reflector 20, a light emitting module 30 and a mirror mount 40, wherein the reflector 20 is a mirror mounted to the mirror mount 40 and the light emitting module 30 is disposed inside the mirror mount 40.

The reflector 20 is adapted to show objects located around the vehicle and provided on a back surface 21 thereof with a cladding layer of aluminum or chromium for reflecting function. The cladding layer is usually very thin, thereby not illustrated in FIG. 2. Besides, the cladding layer is engraved with a light-transmissive pattern 22 by laser engraving, which is provided at a proper position on the back of the reflector 20, such as the position relatively far away from a connecting member 41 of the mirror mount 40 as shown in this embodiment, so that light can be transmitted through the light-transmissive pattern 22 from the back surface 21 of the reflector 20 to the front surface 23 of the reflector 20 to show the light-transmissive pattern 22.

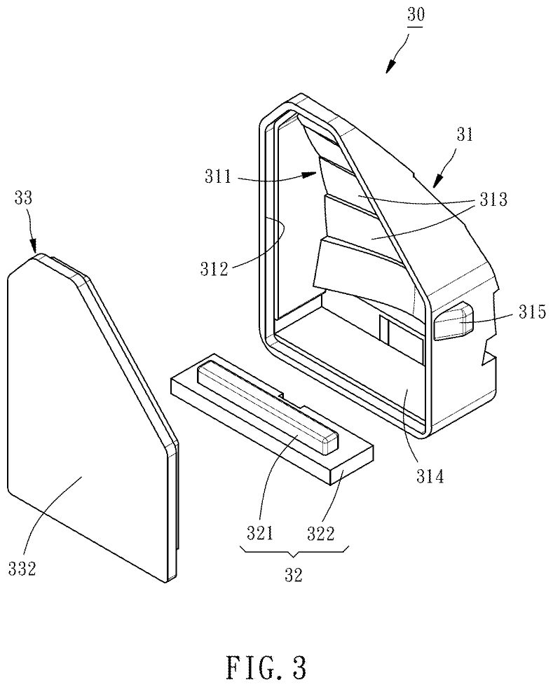

Referring to FIGS. 2-4, the light emitting module 30 includes a reflection base 31, a light source 32 and a lens 33. The reflection base 31 is hollow-shaped and has an accommodating room 311 and an opening 312. The accommodating room 311 communicates with the outside of the light emitting module 30 through the opening 312. The reflection base 31 is provided on the inner wall thereof with four reflection surfaces 313 and an installation surface 314. The reflecting surfaces 313 gradually tilt one after another from bottom to top and face the opening 312 at different angles. The reflection surfaces 313 included in the inner wall of the reflection base 31 are all smooth curved surfaces formed by coating for reflecting light. Besides, the reflection base 31 is provided on the outer surface thereof with two bumps 315 in a way that the light emitting module 30 can be disposed behind the reflector 20 by the bumps 315. Only one of the bumps 315 is shown in FIGS. 2 and 3. The lens 33 is made of acrylic and includes light diffusing agent therein for increasing the light diffusivity of the lens 33. The lens 33 is fixed to the reflection base 31 by ultrasonic welding (or gluing) and covers the opening 312. The lens 33 has an inside surface 331 and an outside surface 332 opposite to the inside surface 331. The inside surface 331 is a matt surface. The outside surface 332 is a smooth surface, which is closely taped to the back surface 21 of the reflector 20 and faces the light-transmissive pattern 22. The light source 32 in this embodiment uses LED, which includes an LED array 321 fixed on a substrate 322 by integrated circuit packaging. The light source 32 is fixed on the installation surface 314 in the accommodating room 311 and faces the reflecting surfaces 313. The LED array 321 can be controlled to emit light in a way that the light emitted by the light source 32 is reflected by the reflecting surfaces 313 to the inside surface 331 of the lens 33, thereby projected to the outside of the light emitting module 30 from the lens 33 and projected to the outside of the reflector 20 through the light-transmissive pattern 22 to show the light-transmissive pattern 22.

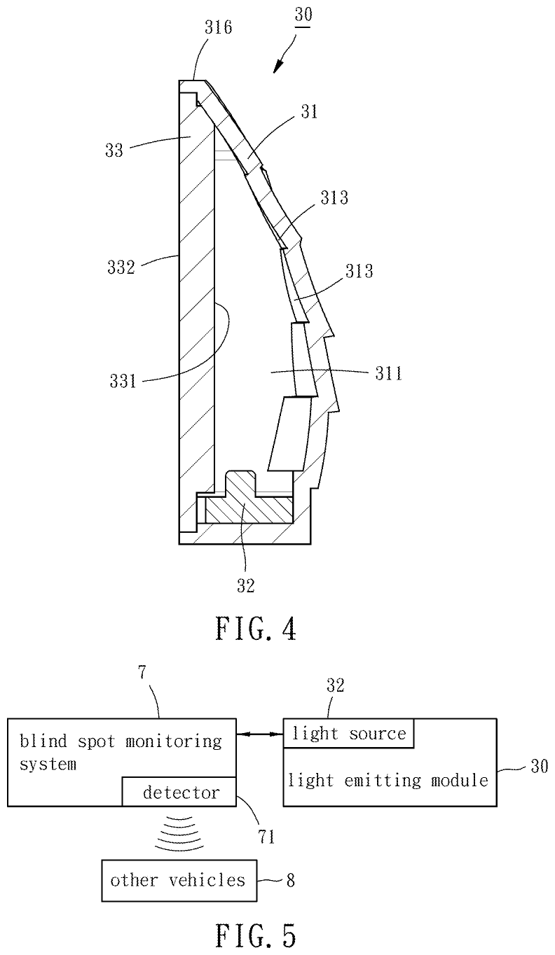

Referring to FIGS. 4 and 5, through the structural design of the above-described rearview mirror 10, when a detector 71 of a blind spot monitoring system 7 of the vehicle detects another vehicle 8 (or a pedestrian) around the vehicle, the blind spot monitoring system 7 activates the light source 32 to emit light, so that the light emitted by the light source 32 is reflected by the above-mentioned plurality of reflecting surfaces 313 gradually tilting one after another to be projected uniformly to the lens 33. Then, through the matt design of the inside surface 331 of the lens 33 and the auxiliary function of the light diffusing agent, the light reflected to the lens 33 is uniformly diffused, so that the light emitting module 30 is capable of emitting a large-area light to the light-transmissive pattern 22 to show the light-transmissive pattern 22 to alert the driver for ensuring the driving safety.

It should be mentioned that in this embodiment the light emitting module 30 is adapted to project a large-area light, so that the whole light emitting module 30 can be regarded as a surface light source, thereby capable of illuminating and showing various light-transmissive patterns 22 with large area and different customized designs.

The above description is only an instanced embodiment of the present invention, and all equivalent changes and modifications made in accordance with the following claims should be included within the scope of the present invention.

What is claimed is:

1. A vehicle rearview mirror comprising:
a reflector having a back surface provided with a light-transmissive pattern; and
a light emitting module disposed behind the reflector, the light emitting module comprising a reflection base, a light source and a lens, the reflection base being hollow-shaped and provided on an inner wall thereof with a plurality of reflecting surfaces, the reflection base having an opening, an inside of the reflection base communicating with an outside of the reflection base through the opening, the reflecting surfaces gradually tilting one after another from bottom to top and facing the opening, the lens being mounted to the reflection base and covering the opening, the lens having an inside surface and an outside surface, the light source being disposed on the reflection base and facing the reflecting surfaces;
wherein the inside surface is a matt surface and the outside surface faces the light-transmissive pattern.

2. The vehicle rearview mirror as claimed in claim 1, wherein the outside surface is a smooth surface.

3. The vehicle rearview mirror as claimed in claim 1, wherein the light source includes an LED array and the light source is fixed in the reflection base.

4. The vehicle rearview mirror as claimed in claim 3, wherein each of the reflecting surfaces is a curved surface.

5. The vehicle rearview mirror as claimed in claim 1, wherein the lens comprises light diffusing agent therein.

6. The vehicle rearview mirror as claimed in claim 1, wherein the light emitting module is directly connected to the back surface of the reflector.

7. The vehicle rearview mirror as claimed in claim 1, wherein the reflection base is provided on an outer surface thereof with a bump; the light emitting module is directly connected to the back surface of the reflector by the bump.

8. The vehicle rearview mirror as claimed in claim 1, wherein each of the reflecting surfaces is a smooth curved surface formed by coating.

9. The vehicle rearview mirror as claimed in claim 1, wherein each of the reflecting surfaces is a curved surface.
